(19) United States
(12) Patent Application Publication
(10) Pub. No.: US 2004/0208433 A1
(43) Pub. Date: Oct. 21, 2004

(54) Apparatus and method for wavelength assignment in WDM optical ring networks

(76) Inventors: Seung-Kwon Cho, Pusan (KR); Moon-Soo Jang, Daejeon (KR); Jae-Deug Jang, Daejeon (KR); Jung-Hoon Oh, Daejeon (KR); Jae-Sun Cha, Cheongju-city (KR)

Correspondence Address: JACOBSON HOLMAN PLLC, 400 SEVENTH STREET N.W., SUITE 600, WASHINGTON, DC, 20004, US

(21) Appl. No.: 10/122,216

(22) Filed: Apr. 16, 2002

(30) Foreign Application Priority Data
Dec. 28, 2001 (KR) 2001-86504

(51) Int. Cl. G02B 6/28; H04J 14/00

(52) U.S. Cl. 385/24; 359/326; 398/57

(57) ABSTRACT

An apparatus for wavelength assignment in wavelength multiplexing optical ring networks includes: a node section receiving a connection setup request, the node section comprising a plurality of nodes; and a wavelength assignment controller connected to the node section for, when the connection setup request occurs, determining paths available between the nodes using sparse wavelength conversion and limited wavelength conversion, calculating the total number of gaps for each node available, and assigning wavelengths to a path having the smallest total number of gaps. The present invention assigns wavelengths in consideration of both sparse wavelength conversion and limited wavelength conversion to minimize the call-blocking probability, and uses the wavelength in adjacent partitions to calculate the number of gaps for each wavelength and the total number of gaps.

### BACKGROUND OF THE INVENTION

(a) Field of the Invention

The present invention relates to an apparatus and method for wavelength assignment in communication systems. More specifically, the present invention relates to an apparatus and method for wavelength assignment in wavelength division multiplexing (WDM) optical ring networks that assigns wavelengths in consideration of conditions of both sparse wavelength conversion and limited wavelength conversion.

(b) Description of the Related Art

With a recent increase in the demand for communications, there is a need for large-capacity and high-speed technologies in the filed of optical communications as well as wireless communication technologies such as asynchronous time division (ATM) switching methods, IMT-2000, LMDS, etc. To fulfill the need for larger capacity, wavelength division multiplexing (WDM) is promising as a key determinant of the optical communication technologies to make the most of a wide bandwidth of an optical fiber.

WDM is a form of optical communication in which the low loss wavelength band of an optical fiber is divided into several narrow channel bandpasses, one bandpass being assigned to each input channel, for simultaneous transmission of input channel signals in the assigned channel bandpass. The WDM communication system can be constructed with passive components and have transparency such that the wavelength channels are independent of each other and irrespective of the transport data format, so that it involves the transmission of a number of different transmission rate signals in parallel as well as the transmission of both analog and digital signals.

The WDM system transmits several scores or several hundreds of intrinsic wavelengths on a single optical fiber so that the transmission rate easily scales up by a factor of several scores or hundreds without additional optical fibers. In using a single transmission line as a plurality of communications lines, a plurality of transmission systems can be constructed from a single optical fiber for wavelength transmission by multiplexing light signals generated from a number of different wavelength light-emitting elements with an optical combiner, and extracting the multiplexed light signals with a dividing filter.

In wavelength transmission using the WDM system, it is necessary to select a wavelength satisfying the wavelength continuity constraint that the same wavelength should be used from source to destination node without a wavelength converter on the path of connection, in order to comply with a connection setup request dynamically applied to the wavelength routing network under dynamic traffic.

Wavelength converters are used to reduce the call-blocking probability of the entire network, because there are some cases where wavelengths available by links cannot be assigned to the requested connection when they do not meet the wavelength continuity requirement.

As a matter of fact, network facilities are limited despite the increased demand of communications, installation of wavelength converters for every node is uneconomical in the aspect of the economy of the network, and the use of additional wavelength converters does not always guarantee a lot of improvement in network performance. Thus, such an economical reduction of the call-blocking probability given to the network using the wavelength converters alone has a limitation. It is therefore reasonable to realize a wavelength assignment algorithm.

In realization of the wavelength assignment algorithm, conditions of both sparse wavelength conversion and limited wavelength conversion are to be taken into consideration.

More specifically, if considering the network's performance versus cost, the performance of an optical network with only 30% of wavelength conversion capability is very close to that of an optical network with full wavelength conversion. So, assigning the wavelength conversion capability to some of the nodes is profitable for economic reasons. In the aspect of an increase in the noise attendant on the wavelength conversion, a network that has a smaller number of wavelength convertible nodes is more desirable than a network that has all wavelength convertible nodes. This form of wavelength conversion is called “sparse wavelength conversion”.

The notion of the sparse wavelength conversion is illustrated in FIG. 1, in which four of the sixteen nodes have the wavelength conversion capability when three wavelengths are given between the adjacent nodes.

To maximize the transparency, the use of an optical converter for converting a light signal into another one of different wavelengths instead of converting the light signal into an electrical signal and restoring it to the light signal is recommended, which reduces the signal-to-noise ratio (SNR) greatly in proportion to the difference between input and output wavelengths. That is, the noise increases with an increase in the conversion range of the input wavelength, thus reducing the transmission rate of the signal.

It is therefore reasonable to perform wavelength conversion with a limited range, not a full range. This form of wavelength conversion is called “limited wavelength conversion”.

The notion of the limited wavelength conversion is illustrated in FIG. 2, in which the full range of wavelength conversion for input wavelength λ₃ is from λ₁ to λ₅. In FIG. 2, the actual range of wavelength conversion is from λ₂ to λ₄ because such a limited-range wavelength conversion of input wavelength λ₃ to λ₂ or λ₄ is more desirable than a wavelength conversion to λ₁ or λ₅ in the aspect of occurrence of noise.

For the same reason, the conditions of both sparse wavelength conversion and limited wavelength conversion must be taken into consideration in realization of wavelength assignment algorithms. But the conventional wavelength assignment algorithms do not consider both of the two wavelength conversions.

There are two conventional algorithms applicable to the conditions of both wavelength conversions without a wavelength converter: one is a first-fit algorithm that sequentially searches available wavelengths and selects the corresponding wavelength, upon reception of a connection setup request; and the other is a random algorithm that searches available wavelengths at random.

However, the two algorithms assign wavelengths according to rules, not dynamically according to the situation of the network, and thus they have a high call-blocking probability.

### SUMMARY OF THE INVENTION

It is an object of the present invention to assign wavelengths dynamically according to the situation of the network in consideration of the conditions of both sparse wavelength conversion and limited wavelength conversion.

It is another object of the present invention to select a wavelength with the smallest total number of gaps in wavelength assignment and to reduce the call-blocking probability with a lesser amount of calculation.

In one aspect of the present invention, there is provided an apparatus for wavelength assignment including: a node section receiving an externally applied connection setup request, the node section comprising a plurality of nodes; and a wavelength assignment controller connected to the node section for, when the connection setup request occurs, determining paths available between the nodes using sparse wavelength conversion and limited wavelength conversion, calculating the total number of gaps for each node available, and assigning wavelengths to a path having the smallest total number of gaps.

The node section includes a plurality of nodes (N nodes), and some of the nodes are wavelength convertible nodes having wavelength conversion capability (Nc wavelength convertible nodes), the node section having partitions each disposed between the wavelength convertible nodes.

The index of the wavelength convertible nodes is given by the following equation:

$$The index of wavelength convertible nodes = [ i \times ( \frac{1}{q} ) ]$$

wherein i=0, 1, 2, . . . , Nc−1; and q is a conversion density of which the decimals are discarded

The wavelength assignment controller calculates the number of gaps for each wavelength in every partition, sums the numbers of gaps calculated to determine the total number of gaps for each wavelength, and selects a wavelength having the smallest total number of gaps as an available wavelength.

First, the wavelength assignment controller calculates the number of gaps for each wavelength in a first partition T_{f} as given by the following equation:

$$\begin{matrix}The number of gaps in partition \\ \begin{matrix} {T}_{f} = {G}_{B} ( {T}_{f} , {λ}_{a} ) & for ‖ C ⋂ {T}_{f} ‖ \neq ‖ {T}_{f} ‖ \\ = {\sum }_{j = min}^{Max} {G}_{B} ( {T}_{( f - 1 ) mod N} , {λ}_{j} ) & for ‖ C ⋂ {T}_{f} ‖ = ‖ {T}_{f} ‖ .\end{matrix}\end{matrix}$$

wherein ∥C∩T_{f}∥ is the number of links in the partition T_{f} for which the connection setup request is made; G_{B}(T_{f},λₐ) is backward gaps for wavelength λₐ in the partition T_{f}; ∥T_{f}∥ is the number of all links in the partition T_{f}; and f is 0, 1, 2, . . . , Nc−1.

Second, the number of gaps for each wavelength in a middle partition Tᵢ is given by the following equation:

The number of gaps in the partition

$${T}_{i} = {\sum }_{j = Min}^{Max} {G}_{B} ( {T}_{( i - 1 ) mod N} , {λ}_{j} )$$

wherein i is 0, 1, 2, . . . , Nc−1.

Finally, the number of gaps for each wavelength in a last partition Tₗ is given by the following equation:

$$The number of gaps in partition {T}_{l} = {\sum }_{j = Min}^{Max} {G}_{B} ( {T}_{( l - 1 ) mod N} , {λ}_{j} ) + {G}_{F} ( {T}_{l} , {λ}_{a} )$$

wherein Min=max(a−k, 0); Max=min(a+k, W−1); W is the number of wavelengths; the number of wavelengths output from one input wavelength by conversion is 2k+1; and l is 0, 1, 2, . . . , Nc−1.

In another aspect of the present invention, there is provided a method for wavelength assignment including: (a) determining whether or not a connection setup request is applied to a node section, the node section comprising a plurality of nodes and having partitions each disposed between wavelength division nodes; (b) determining wavelengths available for every partition, when the connection setup request is applied to the node section; (c) calculating the number of gaps for each wavelength in every partition and then the total number of gaps for each path; and (d) selecting a path having the smallest total number of gaps among the available paths.

The total number of gaps for each path is calculated in consideration of sparse wavelength conversion and limited wavelength conversion, and the index of wavelength convertible nodes is given by the following equation:

$$The index of wavelength convertible nodes = [ i \times ( \frac{1}{q} ) ]$$

wherein i=0, 1, 2, . . . , Nc−1; and q is a conversion density of which the decimals are discarded.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is an illustration explaining the notion of sparse wavelength conversion used in an embodiment of the present invention;

FIG. 2 is an illustration explaining the notion of limited wavelength conversion used in an embodiment of the present invention;

FIG. 3 is a schematic block diagram of an apparatus for wavelength assignment in accordance with an embodiment of the present invention;

FIG. 4 is a schematic flow chart showing a method for wavelength assignment in accordance with an embodiment of the present invention;

FIG. 5 is an illustration showing an example in which the number of gaps for a specific wavelength in one partition is calculated in consideration of limited wavelength conversion in accordance with an embodiment of the present invention;

FIG. 6 is an illustration showing an example of partition division in accordance with an embodiment of the present invention; and

FIGS. 7 to 11 are simulation graphs in which a call-blocking probability is calculated on the basis of each wavelength assigning method.

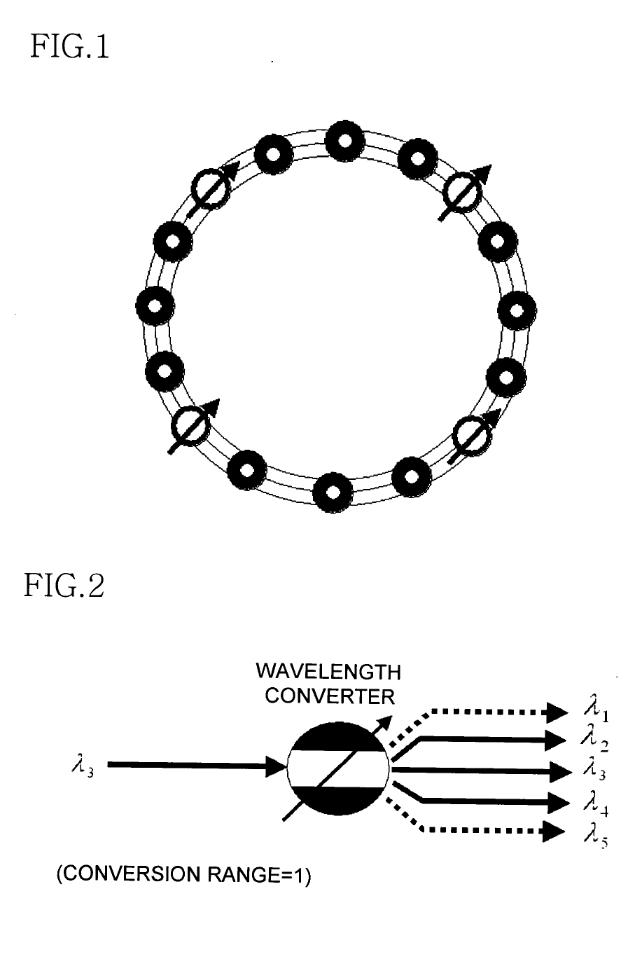

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

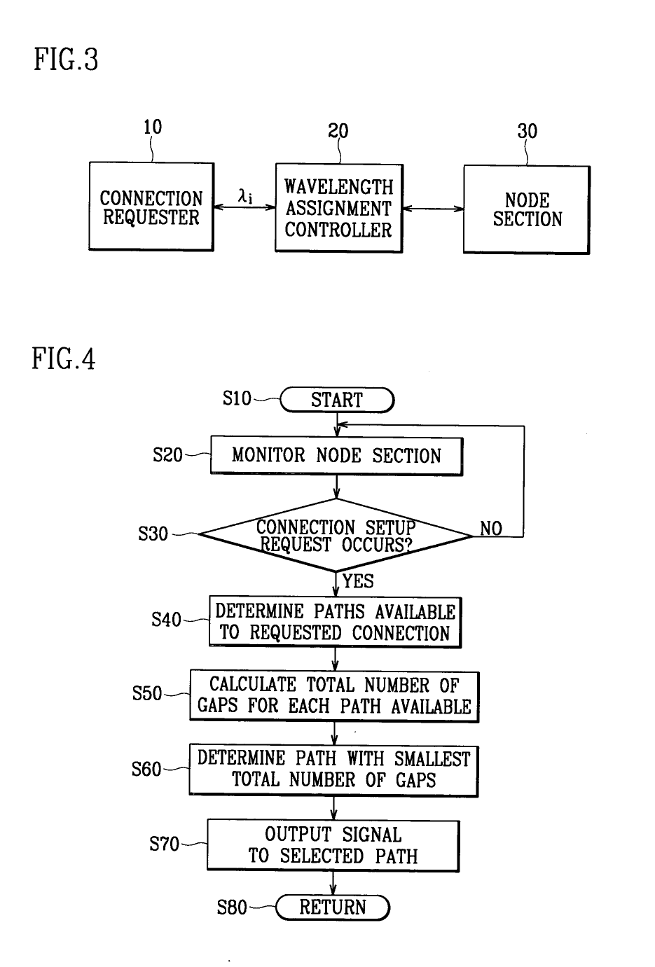

FIG. 3 illustrates the structure of an apparatus for wavelength assignment in accordance with an embodiment of the present invention.

Referring to FIG. 3, the apparatus for wavelength assignment in accordance with the embodiment of the present invention comprises a connection requester 10 for requesting connection setup to a desired designation; a wavelength assignment controller 20 connected to the connection requester 10 for calculating the total number of gaps in every partition and assigning wavelengths to the requested connection via a path with the smallest total number of gaps, when a request for connection setup between nodes occurs; and a node section 30 connected to the wavelength assignment controller 20 and comprising a plurality of nodes for actual connection setup under the control of the wavelength assignment controller 20.

Some of the nodes included in the node section 30 are partition assignment nodes. A set of links between the partition assignment nodes is defined as a “partition”. Each node of the node section 30 has a built-in local controller (not shown) connected to the wavelength assignment controller 20, so that the wavelength assignment controller 20 can judge the state of the individual nodes.

Now, a description will be given to the operation of the above-constructed apparatus for wavelength assignment in accordance with the embodiment of the present invention.

FIG. 4 is a schematic flow chart showing a method for wavelength assignment in accordance with an embodiment of the present invention.

At the start of the operation, in step 10, the wavelength assignment controller 20 examines whether the connection requester 10 sends a connection setup request to a desired node, according to the state of a signal applied from the local controller built into each node of the node section 30, in step 20.

When the connection requester 10 sends a connection setup request to the node section 30, the wavelength assignment controller 20 determines paths available for the connection, in step 40. Otherwise, without a connection setup request, the wavelength assignment controller 20 goes to step 20 to monitor the state of the node section 30.

As stated above, when a connection setup request occurs, the wavelength assignment controller 20 uses sparse wavelength conversion to determine paths available for the connection. In the embodiment of the present invention, the node section 30 comprises 16 nodes N₁ to N₁₆, including 4 wavelength convertible nodes N₂, N₆, N₁₀, and N₁₄, as shown in FIG. 6. A set of links between the wavelength convertible nodes N₂, N₆, N₁₀, and N₁₄ is defined as one partition.

When a connection setup request is sent to the nodes N₁ to N₇, as indicated by arrow C, the operation is affected by three partitions, i.e., partition T_{f} including links between the nodes N₁₄ and N₂, partition Tᵢ including links between the nodes N₂ and N₆, and partition Tₗ including links between the nodes N₆ and N₁₀.

Following the detection of the partitions divided on the basis of the wavelength convertible nodes N₂, N₆, N₁₀, and N₁₄, the wavelength assignment controller 20 separately determines, by partitions T_{f}, Tᵢ, and Tₗ, possible paths from N₁ to N₇ using wavelengths available for the requested connection in each partition.

Subsequently, the wavelength assignment controller 20 uses limited wavelength conversion to calculate the total number of gaps for each wavelength by partitions T_{f}, Tᵢ, and Tₗ and the total number of gaps for each path, in step 50.

In the embodiment of the present invention, a gap is defined as a set of successive links having the same wavelength available after assignment of wavelengths.

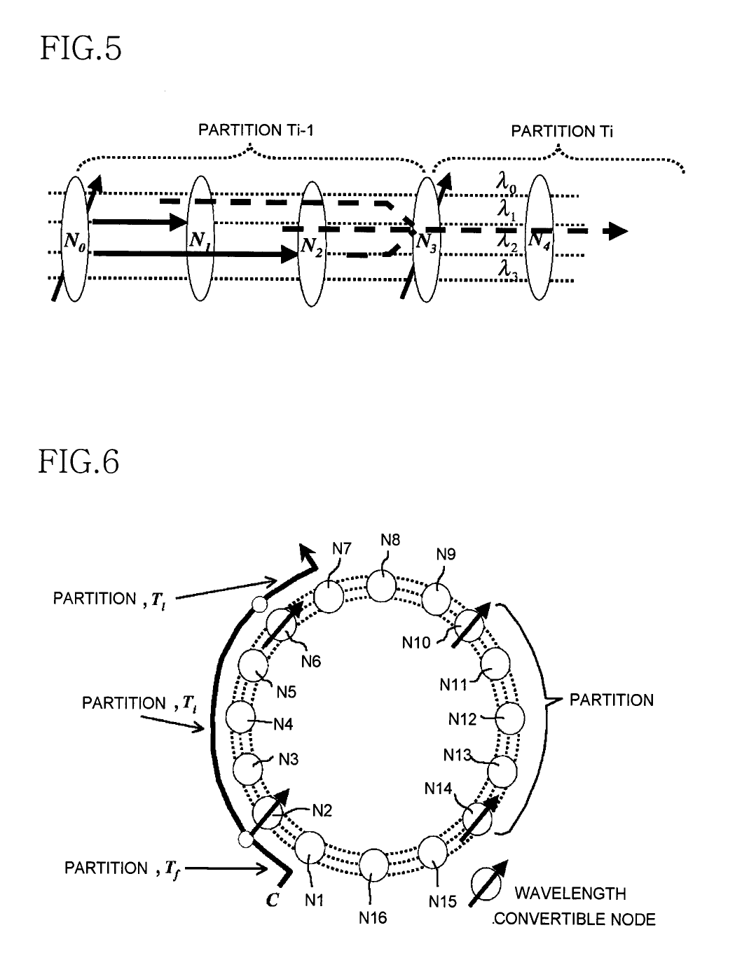

Now, a description will be given to the principles of operation for calculating the number of gaps by partitions T_{f}, Tᵢ, and Tₗ in the embodiment of the present invention with reference to FIG. 5.

FIG. 5 is an illustration showing an example in which the number of gaps for a specific wavelength in one partition is calculated in consideration of limited wavelength conversion in accordance with an embodiment of the present invention, where k=1.

Let G_{B}(Tᵢ, j) and G_{F}(Tᵢ, j) be backward and forward gaps for wavelength λᵢ, respectively. Then the gap of λ₁ in partition Tᵢ is defined as the sum total of the backward gaps of λ₀, λ₁, and λ₂ in partition Tᵢ₋₁, that are convertible to λ₁ in partition Tᵢ.

This can be expressed by the following equation:

$$The gap of {λ}_{1} in partition {T}_{i} = {\sum }_{j = 0}^{2} {G}_{B} ( {T}_{i - 1} , {λ}_{j} ) \qquad [ Equation 1 ]$$

Here the number of gaps for a wavelength λ₁ in the partition Tᵢ is calculated by summing up the number of backward gaps of wavelengths that can be converted into λ₁ in partition Tᵢ.

As such, the embodiment of the present invention determines the number of gaps for the corresponding wavelength as the total number of gaps for wavelengths in the neighboring partition only, and thereby reduces the amount of calculation.

FIG. 6 is an illustration showing an example of partition division in accordance with an embodiment of the present invention.

An equation for calculating the sum total of gaps in the individual partitions T_{f}, Tᵢ, and Tₗ for an available wavelength λₐ can be given as follows. (where a=0, 1, 2, . . . , W−1)

First, the number of gaps in partition T_{f} is given by:

$$\begin{matrix}The number of gaps in partition \\ \begin{matrix} {T}_{f} = {G}_{B} ( {T}_{f} , {λ}_{a} ) & for ‖ C ⋂ {T}_{f} ‖ \neq ‖ {T}_{f} ‖ \\ = {\sum }_{j = Min}^{Max} {G}_{B} ( {T}_{( f - 1 ) mod N} , {λ}_{j} ) & for ‖ C ⋂ {T}_{f} ‖ = ‖ {T}_{f} ‖\end{matrix}\end{matrix} \qquad [ Equation 2 ]$$

Here ∥C∩T_{f}∥ is the number of links in partition T_{f} for which a connection setup request is made; G_{B}(T_{f},λₐ) is the backward gaps for wavelength λ in partition T_{f}; and ∥T_{f}∥ is the number of all links in partition T_{f}.

Second, the number of gaps in partition Tᵢ is calculated as:

$$The number of gaps in partition {T}_{i} = {\sum }_{j = Min}^{Max} {G}_{B} ( {T}_{( i - 1 ) mod N} , {λ}_{j} ) \qquad [ Equation 3 ]$$

Finally, the number of gaps in partition Tₗ is given by:

$$The number of gaps in partition {T}_{l} = {\sum }_{j = Min}^{Max} {G}_{B} ( {T}_{( l - 1 ) mod N} , {λ}_{j} ) + {G}_{F} ( {T}_{l} , {λ}_{a} ) \qquad [ Equation 4 ]$$

Here Min=max(a−k, 0); Max=min(a+k, W−1); W is the number of wavelengths; the number of wavelengths output from one input wavelength by conversion is 2k+1; and f, i, and l are 0, 1, 2, . . . , Nc−1.

Hence, the total number of gaps in each wavelength is the sum of the respective numbers of gaps for each wavelength in the individual partitions T_{f}, Tᵢ, and Tₗ. That is, the total number of gaps=[Equation 2]+[Equation 3]+[Equation 4].

After using the above equations to calculate the number of gaps for each wavelength in the individual partitions T_{f}, Tᵢ, and Tₗ according to the connection setup request and then the total number of gaps for each wavelength, the wavelength assignment controller 20 determines a path that has the smallest total number of gaps, in step 60, and selects wavelengths available.

The reason for choosing the path that has the smallest total number of gaps is that the reduction of the capacity of the network after connection setup is minimized, and accordingly, the capacity of connections available during the subsequent connection assignment is increased, when the connection is assigned to the path that has the smallest total sum of gaps in the case the capacity of the entire network that indicates the number of connections acceptable to the network is defined as the function of the gaps.

Subsequently, the wavelength assignment controller 20 outputs a control signal to the corresponding local controller of the node section 30 to choose a path that has the smallest total number of gaps, in step 70.

Therefore, each corresponding local controller of the node section 30 achieves efficient connection assignment to the destination node through the selected wavelengths via the connection requester 10 according to the control signal received from the wavelength assignment controller 20.

Now, a comparison will be made between the present invention and the conventional methods.

For this purpose, a simulation is performed that uses the uniform Poisson distribution for modeling the arrival of connection and the exponential distribution for modeling the service time of connection. The present invention is then compared with the conventional methods in regard to the call-blocking probability for the individual parameters.

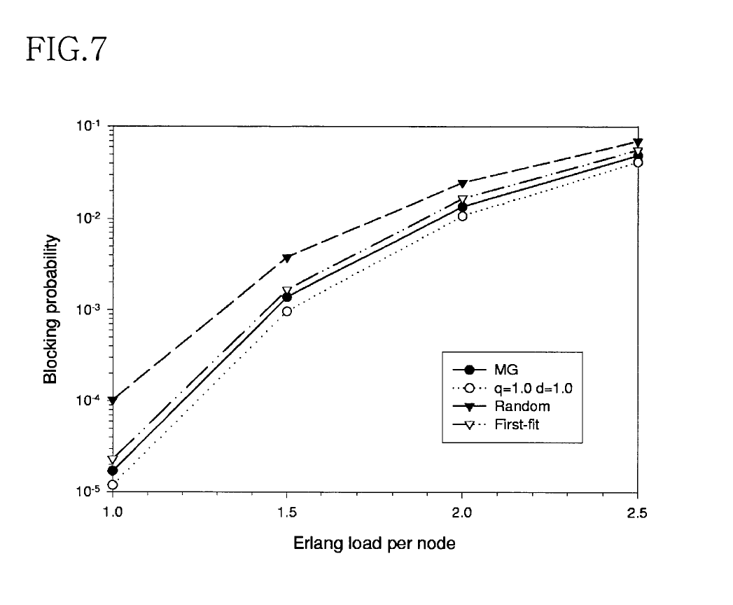

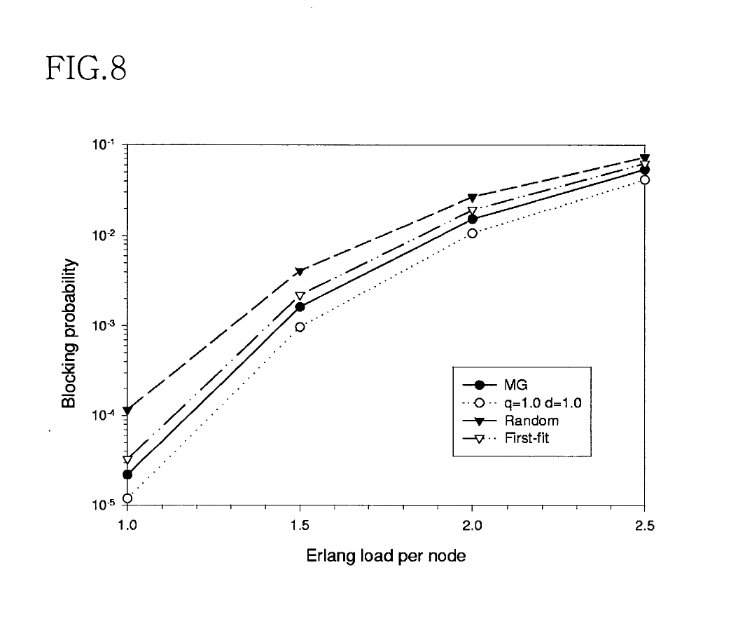

FIGS. 7 and 8 illustrate the results of a simulation for an optical ring network that has eight nodes and sixteen wavelengths per link.

In FIG. 7, the percentage of wavelength convertible nodes is 25%, and 100% wavelength conversion is enabled. The dotted line shows the least call-blocking probability of a network having a given number of nodes in the case of 100% wavelength conversion in all nodes. Compared with the conventional methods irrespective of the load of the network, the present invention has the least call-blocking probability for any load of the node as indicated by the minimum gap (MG), and maximizes the performance of the network.

In FIG. 8, the percentage of wavelength convertible nodes is 25%, and 30% wavelength conversion is enabled. The present invention also has the least call-blocking probability in this case, as indicated by the minimum gap (MG).

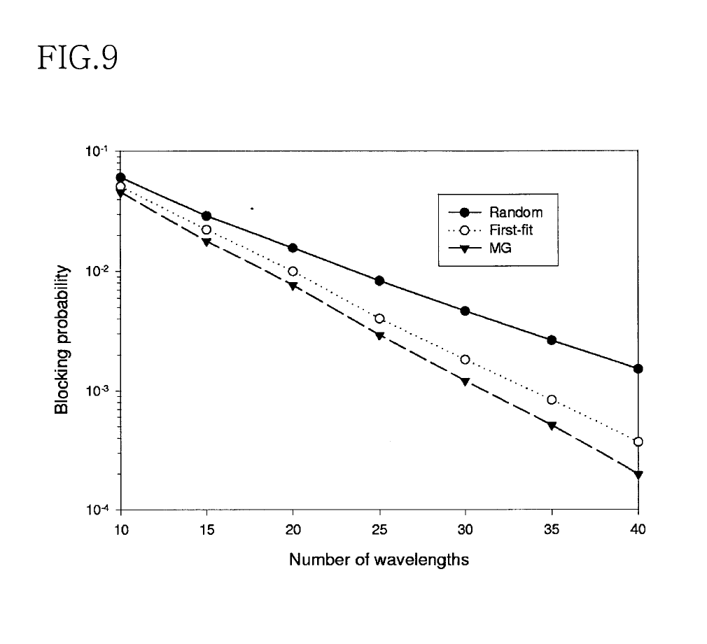

FIG. 9 shows the call-blocking probability with an increase in the number of wavelengths per link. As is apparent from FIG. 9, with an increase in the number of wavelengths, there is a significant difference in the call-blocking probability between wavelength assignment algorithms. And the algorithm of the present invention (MG) facilitates a great reduction of the call-blocking probability.

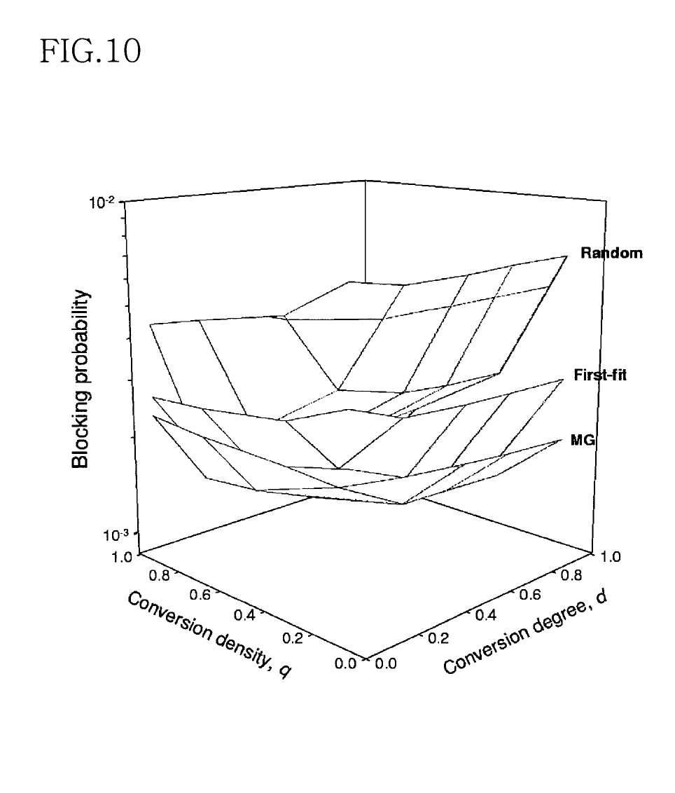

FIG. 10 shows the call-blocking probability that depends on the ratio of the number of wavelength convertible nodes to the total number of nodes, i.e., conversion density q and the wavelength conversion degree d. When q=d=1.0, the network performance amounts to the maximum and the graphs of all methods reaches one point that indicates the maximum network performance. Also in FIG. 10, the algorithm of the present invention (MG) has the least call-blocking probability.

More specifically, the effects of the two parameters on the call-blocking probability are independent of each other and the plane has the maximum slope when both the two parameters are 0.25. So the network of which the conversion density and the conversion degree are each 25% has a structure that minimizes cost and noise during wavelength conversion, and maximizes the gain acquired from the wavelength conversion. The least call-blocking probability can be achieved when these nodes are uniformly distributed in the network, as shown in FIG. 6. For a given ratio of the number of wavelength convertible nodes to the total number of nodes, i.e., a given conversion density q, the index of the wavelength convertible nodes is given by:

$$The index of wavelength convertible nodes = [ i \times ( \frac{1}{q} ) ] \qquad [ Equation 5 ]$$

Here i=0, 1, 2, . . . , Nc−1; and q is the conversion density of which the decimals are discarded.

Though the present invention detects the wavelength having the least call-blocking probability in consideration of both limited wavelength conversion and sparse wavelength conversion, it can still be applied to a network with no wavelength conversion, because such a network is considered as a special example of limited wavelength conversion and sparse wavelength conversion, where q=d=0.

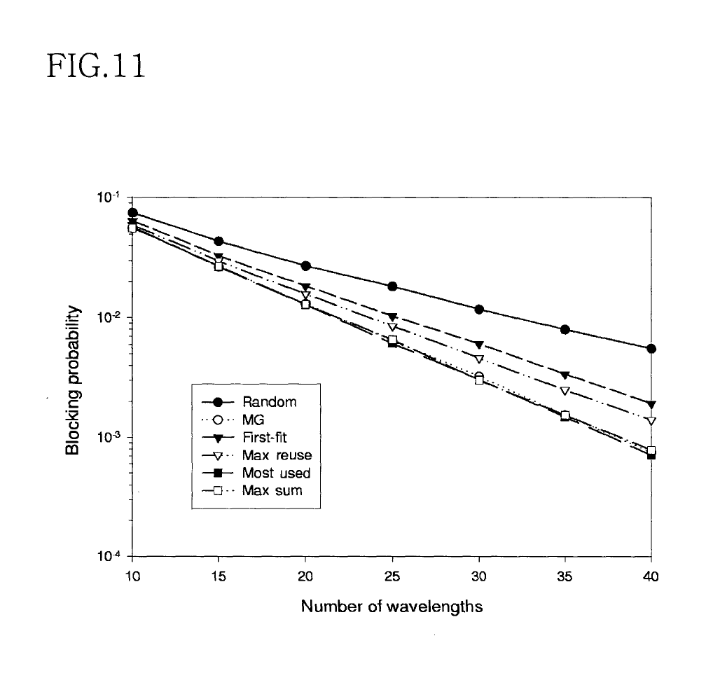

FIG. 11 shows the results of a comparison in algorithms between the embodiment of the present invention and other methods in the network with no wavelength conversion.

It can be seen from FIG. 11 that the call-blocking probability of a network without wavelength conversion in the present invention is very close to that of a network optimized in the other methods.

As described above, the present invention involves wavelength assignment in consideration of both sparse wavelength conversion and limited wavelength conversion to minimize the call-blocking probability, and uses the wavelengths in adjacent partitions to calculate the number of gaps for each wavelength, thereby reducing the amount of calculation.

By considering both sparse wavelength conversion and limited wavelength conversion, the present invention assigns wavelengths dynamically according to the situation of the current network to reduce noise and enhance the efficiency of wavelength assignment. The present invention also decreases the number of wavelength converters or the range of wavelength conversion for meeting the call-blocking probability given in designing the network, thus reducing the cost of the entire network.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. An apparatus for wavelength assignment comprising:
a node section receiving an externally applied connection setup request, the node section comprising a plurality of nodes; and
a wavelength assignment controller connected to the node section for, when the connection setup request occurs, determining paths available between the nodes by use of sparse wavelength conversion and limited wavelength conversion, calculating the total number of gaps for each node available, and assigning wavelengths to a path having the smallest total number of gaps.

2. The apparatus as claimed in claim 1, wherein the node section comprises a plurality of nodes and some of the nodes are wavelength convertible nodes having wavelength conversion capability, the node section having partitions each disposed between the wavelength convertible nodes.

3. The apparatus as claimed in claim 2, wherein the index of the wavelength convertible nodes is given by the following equation:
$$The index of wavelength convertible nodes = [ i \times ( \frac{1}{q} ) ]$$
wherein i=0, 1, 2, . . . , Nc−1; and q is a conversion density, that is, the ratio of the number of wavelength convertible nodes to the total number of nodes, of which the decimals are discarded.

4. The apparatus as claimed in claim 2, wherein the wavelength assignment controller calculates the number of gaps for each wavelength in every partition, sums the numbers of calculated gaps to determine the total number of gaps for each wavelength, and selects a wavelength having the smallest total number of gaps as an available wavelength.

5. The apparatus as claimed in claim 4, wherein the wavelength assignment controller calculates the number of gaps for each wavelength in a first partition T_{f} as given by the following equation:
$$\begin{matrix}\begin{matrix}The number of \\ gaps in partition {T}_{f}\end{matrix} = {G}_{B} ( {T}_{f} , {λ}_{a} ) for ‖ C ⋂ {T}_{f} ‖ \neq ‖ {T}_{f} ‖ \\ = {\sum }_{j = Min}^{Max} {G}_{B} ( {T}_{( f - 1 ) mod N} , {λ}_{j} ) \\ for ‖ C ⋂ {T}_{f} ‖ = ‖ {T}_{f} ‖\end{matrix}$$
wherein ∥C∩T_{f}∥ is the number of links in the partition T_{f} for which the connection setup request is made; G_{B}(T_{f},λₐ) is backward gaps for wavelength λ in the partition T_{f}; ∥T_{f}∥ is the number of all links in the partition T_{f}; and f is 0, 1, 2, . . . , Nc−1.

6. The apparatus as claimed in claim 4, wherein the wavelength assignment controller calculates the number of gaps for each wavelength in a middle partition Tᵢ as given by the following equation:
$$\begin{matrix}The number of gaps \\ in the partition {T}_{i}\end{matrix} = {\sum }_{j = Min}^{Max} {G}_{B} ( {T}_{( i - 1 ) mod N} , {λ}_{j} )$$
wherein i is 0, 1, 2, . . . , Nc−1.

7. The apparatus as claimed in claim 4, wherein the wavelength assignment controller calculates the number of gaps for each wavelength in a last partition T_{f} as given by the following equation:
$$\begin{matrix}The number of gaps \\ in the partition {T}_{l}\end{matrix} = {\sum }_{j = Min}^{Max} {G}_{B} ( {T}_{( l - 1 ) mod N} , {λ}_{j} ) + {G}_{F} ( {T}_{l} , {λ}_{a} )$$
wherein Min=max(a−k, 0); Max=min(a+k, W−1); W is the number of wavelengths; the number of wavelengths output from one input wavelength by conversion is 2k+1; and l is 0, 1, 2, . . . , Nc−1.

8. A method for wavelength assignment comprising:
(a) determining whether or not a connection setup request is applied to a node section, the node section comprising a plurality of nodes and having partitions each disposed between wavelength division nodes;
(b) determining wavelengths available for every partition, when the connection setup request is applied to the node section;
(c) calculating the number of gaps for each wavelength in every partition and then the total number of gaps for each path; and
(d) selecting a path having the smallest total number of gaps among the available paths,
wherein the total number of gaps for each path is calculated in consideration of sparse wavelength conversion and limited wavelength conversion, wherein the index of wavelength convertible nodes is given by the following equation:
$$The index of wavelength convertible nodes = [ i \times ( \frac{1}{q} ) ]$$
wherein i=0, 1, 2, . . . , Nc−1; and q is a conversion density of which the decimals are discarded.

9. The method as claimed in claim 8, wherein the step (c) comprises calculating the number of gaps for each wavelength in a first partition T_{f} as given by the following equation:
$$\begin{matrix}\begin{matrix}The number of gaps \\ in partition {T}_{f}\end{matrix} = {G}_{B} ( {T}_{f} , {λ}_{a} ) for ‖ C ⋂ {T}_{f} ‖ \neq ‖ {T}_{f} ‖ \\ = {\sum }_{j = Min}^{Max} {G}_{B} ( {T}_{( f - 1 ) mod N} , {λ}_{j} ) \\ for ‖ C ⋂ {T}_{f} ‖ = ‖ {T}_{f} ‖\end{matrix}$$
wherein ∥C∩T_{f}∥ is the number of links in the partition T_{f} for which the connection setup request is made; G_{B}(T_{f},λₐ) is backward gaps for wavelength λ in the partition T_{f}; ∥T_{f}∥ is the number of all links in the partition T_{f}; and f is 0, 1, 2, . . . , Nc−1.

10. The method as claimed in claim 8, wherein the step (c) comprises calculating the number of gaps for each wavelength in a middle partition Tᵢ as given by the following equation:
$$\begin{matrix}The number of gaps \\ in the partition {T}_{i}\end{matrix} = {\sum }_{j = Min}^{Max} {G}_{B} ( {T}_{( i - 1 ) mod N} , {λ}_{j} )$$
wherein i is 0, 1, 2, . . . , Nc−1.

11. The method as claimed in claim 8, wherein the step (c) comprises calculating the number of gaps for each wavelength in a last partition Tₗ as given by the following equation:
$$\begin{matrix}The number of gaps \\ in the partition {T}_{l}\end{matrix} = {\sum }_{j = Min}^{Max} {G}_{B} ( {T}_{( l - 1 ) mod N} , {λ}_{j} ) + {G}_{F} ( {T}_{l} , {λ}_{a} )$$
wherein Min=max(a−k, 0); Max=min(a+k, W−1); W is the number of wavelengths; the number of wavelengths output from one input wavelength by conversion is 2k+1; and l is 0, 1, 2, . . . , Nc−1.
